(19) United States
(12) Patent Application Publication
(10) Pub. No.: US 2014/0096969 A1
(43) Pub. Date: Apr. 10, 2014

(54) COMPOSITIONS AND METHODS FOR PREVENTING EMULSION FORMATION

(71) Applicants: Syed Afaq Ali, Sugar Land, TX (US); Yenny Christanti, Houston, TX (US)

(72) Inventors: Syed Afaq Ali, Sugar Land, TX (US); Yenny Christanti, Houston, TX (US)

(21) Appl. No.: 13/644,686

(22) Filed: Oct. 4, 2012

(51) Int. Cl. C09K 8/68; E21B 43/26; E21B 43/25

(52) U.S. Cl. CPC C09K 8/68; E21B 43/25; E21B 43/26
USPC 166/308.1; 166/305.1; 507/218

(57) ABSTRACT

A method is described for treating a formation adjacent a subterranean well with a treatment fluid composition imparted with emulsion formation prevention properties. A microemulsion additive is mixed into a treatment fluid component to form a volume of a treatment fluid composition having emulsion formation prevention properties. The microemulsion additive is composed of a mixture solvent, a co-solvent, a mutual solvent, a non-emulsifier, a non-ionic surfactant, a non-ionic co-surfactant, alcohol, an emulsifying surfactant, and an aqueous fluid. The volume of the fluid composition is then injected into the subterranean well and contacts the formation, whereby the microemulsion additive in the treatment fluid volume acts to prevent emulsion formation in the formation.

### BACKGROUND

The present disclosure relates generally to compositions and methods for treating a subterranean well and\or adjacent formation. More specifically, the present disclosure relates to fluid compositions and methods for treating a subterranean well and\or adjacent formation with a fluid having a microemulsion component, so as to alleviate emulsion formation in the well and adjacent formation. In one aspect, the present disclosure relates to a microemulsion composition provided as an additive to a treatment fluid such as a fracturing fluid, so as to prevent, mitigate, or otherwise alleviate oil and water emulsions in the well or adjacent formation.

Some statements may merely provide background information related to the present disclosure and may not constitute prior art.

Various stimulation techniques entail the injection of treatment fluids into a well and adjacent formation. In most instances, the aim of the technique is to treat the well or formation and\or the contents in the well so as to facilitate or enhance recovery of hydrocarbons, drilling fluids, or the like. Hydraulic fracturing is one such well stimulation process employed to facilitate the extraction of oil and natural gas resources from a geologic formation. The process aims to enhance subsurface fracture and flow systems by enlarging and\or extending the fractures, thereby facilitating and maximizing oil or natural gas movement from the rock pores to production wells (and then to the surface). Fluids, commonly made up of water and chemical additives, are pumped into the geologic formation at a pressure sufficiently high to cause the fractures to open or enlarge. These fractures extend and form passageways from the well into the formation. A propping agent or proppant may then be pumped into the fractures to prevent the passageways from closing. After completion of the fracturing process, the injected fracturing fluids flow back into the well and brought to the surface for recovery.

A recurring problem associated with fracturing and other treatment well operations is the formation of highly viscous emulsions. Emulsions are a mixture of two or more substances that cannot blend, which, in the case of well treatment operations, comprise oil in water or water in oil mixtures. Emulsions are known to form as fluid filtrates or injected fluids and reservoir fluids mix. Generally, if the interface between the oil and water phases is not stabilized, the substances that make up the emulsions will readily separate. The severity of the emulsions depends on several factors including the physical and chemical properties of the oil, temperature, and the presence of solids and other chemicals that act to stabilize the emulsion. Further, certain well stimulation techniques are known to cause, or are associated with, conditions that foster the formation and stabilization of these oil and water emulsions. For example, an injection of a large volume of fluid into the well or a release of formation fines, each of which is often associated with certain stimulation techniques, tend to promote emulsion formation. Conditions for emulsion formation are also heightened when there is a significant change in the pH of the reservoir fluids, which also occurs or made necessary during some well stimulation techniques. For example, the treatment fluid introduced into the well may be formulated or adjusted to have a relatively high pH. In the particular case of hydraulic fracturing processes, recent field case histories confirm that emulsions tend to form and stabilize after fracturing in oil or condensate producing shales and tight gas sands. It appears that certain crude oils and condensates exhibit acute emulsification tendencies after contacting filtrate that flow back from the formation after fracturing.

The presence of emulsions can hinder the productivity of the well, complicate well operations, and increase costs. To address emulsion formation concerns, well operators employ demulsifiers that are specifically designed to break up oil and water emulsion systems. Conventional demulsifiers are usually chemicals that, when introduced into the well, cause a reaction that tends to eliminate the interfacial film about the emulsion's dispersed phase and destabilizes the emulsion. For example, the demulsifier may cause flocculation of the oil droplets, dropping of the water, and/or coalescence of the water droplets. In any event, the water phase and the oil phase are separated.

With ever increasing production demands, it remains critical to mitigate emulsion formation buildup during different well treatment operations so as to enhance or maintain productivity. It also important to alleviate emulsion concerns to so as to facilitate the recovery of drilling fluids and fracturing fluids from formations and prepare for safe disposal of these fluids at the surface. Accordingly, there is a need to provide improve compositions and methods for treating a subterranean well and formation that are effective in alleviating oil and water emulsions under various conditions and well operations, including fracturing operations utilizing high pH fracturing fluids.

### SUMMARY

The present document discloses compositions and methods for treating a subterranean well and\or formation. The present document further discloses methods for treating a subterranean well and formation with a fluid having a microemulsion component, thereby preventing, mitigating or otherwise alleviating oil and water emulsion formation. Also disclosed are fluid compositions particularly suited for use with such methods. In one set of embodiments, a microemulsion composition is provided as an additive to a treatment fluid such as a fracturing fluid, so as to prevent, mitigate, or otherwise alleviate oil and water emulsions in the well or adjacent formation. The microemulsion composition in these embodiments provide a microemulsion system or structure that acts as an effective carrier for and includes a non-emulsifier. In an exemplary application described herein, a microemulsion composition is used with a high pH fracturing fluid, such as a borate-crosslinked or zirconium-crosslinked fracturing fluid, to prevent fracturing fluid-induced crude oil or condensate emulsions.

In one aspect, a method is described for treating a formation adjacent a subterranean well with a treatment fluid composition imparted with emulsion formation prevention properties. The method entails providing a treatment fluid and mixing a microemulsion additive into the treatment fluid component to form a volume of a treatment fluid composition having emulsion formation prevention properties. The microemulsion additive comprises a solvent package (e.g., mixture solvent, a co-solvent, and a mutual solvent), a non-emulsifier, an emulsifying surfactant, and an aqueous fluid. In some embodiments, the microemulsion additive also contains one or more water wetting surfactants (e.g., a non-ionic surfactant and a non-ionic co-surfactant) and further, an alcohol. The volume of the fluid composition is then injected into the subterranean well and contacts the formation, whereby the microemulsion additive in the treatment fluid volume acts to prevent emulsion formation in the formation. In one embodiment, the treatment fluid is a fracturing fluid and the injection step generates fractures in the formation. In a further embodiment, the fracturing fluid is a high pH (e.g. between about 9 and 13) fracturing fluid, such as high pH slick water or zirconium-crosslinked or borate-crosslinked fracturing fluid.

In another aspect, a microemulsion additive composition is provided for adding to a well treatment fluid and imparting emulsion formation prevention properties to the treatment fluid. The composition comprises a solvent package, a non-emulsifier, a water wetting surfactant, an emulsifying surfactant, and an aqueous fluid. In some embodiments, the non-emulsifier is a “green” non-emulsifier, and the composition also includes a non-ionic co-surfactant (a water wetting surfactant) and alcohol.

In a further aspect, embodiments are directed to a method for preventing emulsion formation in a subterranean well and adjacent formation. The method entails preparing a microemulsion additive composition that is a single phase water-external microemulsion. The microemulsion is composed of a mixture solvent, a co-solvent, a mutual solvent, a non-emulsifier, a non-ionic surfactant, a non-ionic co-surfactant, alcohol, an emulsifying surfactant, and water. After preparing a well treatment component, a microemulsion additive is mixed into the well treatment component to form a volume of a treatment fluid composition having emulsion formation prevention properties, wherein the microemulsion additive composition is miscible in the treatment fluid. The method then requires introducing the volume of the treatment fluid composition into the subterranean well and contacting the formation therewith for treatment, whereby the microemulsion additive in the treatment fluid volume acts to prevent oil emulsion formation inside the well and formation contacted by the treatment fluid volume.

In yet another aspect, a fracturing fluid composition is provided that exhibits emulsion formation prevention properties in a subterranean well and adjacent formation. The composition is composed of a fracturing fluid component and a microemulsion additive. The additive is further composed of a mixture solvent, a co-solvent, a mutual solvent, a non-emulsifier, a non-ionic surfactant, a non-ionic co-surfactant, an alcohol, an emulsifying surfactant, and an aqueous fluid, wherein the microemulsion additive is a single phase water external microemulsion and is miscible in the fracturing fluid component.

### BRIEF DESCRIPTION OF THE DRAWINGS

The accompanying Figures, which are incorporated in and constitute a part of this specification, illustrate several aspects described below.

FIG. 1 is a photograph of sample mixtures of water and various demulsifiers and a microemulsion additive according one embodiment;

FIG. 2 is a graphical representation of the demulsification efficiency of a microemulsion additive according to one embodiment;

FIG. 3 is a post-breakout photograph of various brine-crude oil sample mixtures treated with a microemulsion additive according to one embodiment;

FIG. 4 is a graphical representation of the demulsification efficiency of various demulsifiers as compared to that of a microemulsion additive according to one embodiment;

FIG. 5 is a post-breakout photograph of the various brine-crude oil sample mixtures represented in FIG. 4;

FIG. 6 is a graphical representation of the effect on the viscosity of various fracturing fluid, according to one embodiment;

FIG. 7 is a graphical representation of non-emulsion test results on fracturing fluid-crude oil sample mixtures; and

FIG. 8 is a post-breakout photograph of the fracturing fluid filtrate-crude oil sample mixtures represented in FIG. 7.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. The description and examples are presented solely for the purpose of illustrating the some embodiments should not be construed as a limitation to the scope and applicability of the disclosed embodiments. While the compositions of the present disclosure are described herein as comprising certain materials, it should be understood that the composition could optionally comprise two or more chemically different materials. In addition, the composition can also comprise some components other than the ones already cited.

In the Summary and the Detailed Description, each numerical value should be read once as modified by the term “about” (unless already expressly so modified), and then read again as not so modified unless otherwise indicated in context. Also, in the Summary and the Detailed Description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific data points, it is to be understood that the Applicants appreciate and understand that any and all data points within the range are to be considered to have been specified, and that the Applicants have disclosed and enabled the entire range and all points within the range.

Various applications are described in which an improved fluid composition is introduced into a well and\or adjacent formation. The fluid composition referred to may be of a class of treatment fluid compositions specially formulated for a certain well treatment as known in the art, but provided with a microemulsion component that imparts demulsification and emulsion prevention properties to the fluid composition (i.e., when the fluid composition is introduced into the well and adjacent formation). As further disclosed and, as used and described herein, the terms “preventing emulsion formation”, “demulsification and emulsion prevention”, and “'alleviating emulsion formation” shall refer to and encompass the act of demulsifying emulsions, whether stable or unstable, as well as inhibiting the formation and\or stabilization of such emulsions. In the same context, methods that refer to actions on or in the subterranean well shall also mean and apply to the wellbore and the adjacent formation. Example of well treatment operations include, but are not limited to, acidizing and hydraulic fracturing techniques.

Microemulsions are macroscopically homogeneous mixtures of oil, water and surfactant. They form upon simple mixing of the components, and do not require the high-shear conditions generally required for creating ordinary emulsions. Microemulsions are thermodynamically, not kinetically, stabilized, and may consist of one, two or three phases. Microemulsions may consist of oil dispersed in water (0/W) or water dispersed in oil (W/0) emulsions. Microemulsions are generally described as Winsor Type I, II, III or IV emulsions. A system or formulation is defined as: Winsor I when it contains a microemulsion in equilibrium with an excess oil phase; Winsor II when it contains a microemulsion in equilibrium with excess water; Winsor III when it contains a middle phase microemulsion in equilibrium with excess water and excess oil; and Winsor IV when it contains a single-phase microemulsion with no excess oil or excess water. More information about microemulsions and especially about Winsor IV can be found in S. Ezrahi, A. Aserin and N. Garti, “Chapter 7: Aggregation Behavior in One-Phase (Winsor IV) Microemulsion Systems”, in P. Kumar and K. L. Mittal, ed., Handbook of Microemulsion Science and Technology, Marcel Dekker, Inc., New York, 1999, pp. 185-246, the entire content of which is incorporated by reference into the current disclosure.

Detailed descriptions of the subject fluid composition and methods of employing the same are presented primarily in the context of well stimulation techniques and fluids, and more specifically, fracturing fluid compositions and fracturing methods. These foregoing descriptions of exemplary applications are provided for illustration and to add clarity to concepts, and should not be construed in any way as limiting the scope and possible applications of the described concepts. For example, the well treatment techniques and treatment fluid compositions may be regarded as mechanisms for administering the microemulsion additive, and the emulsion formation prevention agents carried by the microemulsion additive, to target oil and water in the well and formation. It would be understood by those skilled in the relevant chemical, geophysical, or other applicable art that various other fluid compositions, perhaps subject to modification, may serve in the same regard. Other well-related processes that entail the introduction of fluids into the well may, perhaps with modification, be suitable for administering the microemulsion additive of the present disclosure. It is noted, however, that the microemulsion additive is particularly suited for use with or in certain well treatment processes, or more specifically, stimulation techniques, because these processes usually involve the introduction of a large volume of fluid into the well, a mix of crude oils, condensate, and other substances with well fluids that lead to emulsion formation, and hydrocarbon product ready for and in need of cleaner and efficient extraction.

In one application, the well treatment is a fracturing operation and a fracturing fluid composition is prepared with a microemulsion additive having emulsion formation prevention properties. In the fracturing method, the fracturing fluid containing the microemulsion is used to contact the formation (e.g., in an otherwise conventional hydraulic fracturing operation) and stimulate or enhance production. Generally, fracturing fluid is pumped into the wellbore at a rate sufficient to increase pressure downhole and exceed that of the fracture gradient (pressure gradient) of the rock formation, thereby creating the desired hydraulic fracture. As the rock fractures, the fracture fluid continues further into the formation and extends the fracture. After fluid pressure generated by the fracturing process is released, the fracturing fluid and filtrates from the formation drain back to the wellbore. The microemulsion in some embodiments is added to (mixed with) the fracturing fluid prior to pumping and, during the pumping operation, is introduced into the well and the formation with the fracturing fluid. As the fracturing fluid reaches the extent of the formation and becomes a part of the reservoir fluid makeup, the microemulsion composition may be described as being administered in or to the well and its fluid content. The microemulsion composition acts to prevent emulsions from forming (in and between the mix of fracturing fluid, filtrate and oil) as in preventing the emulsion constituents from coming together or from stabilizing. More particularly, the non-emulsifier carried in the composition is administered and acts upon the target oil and water emulsions. The composition may also be described as preventing the formation of emulsions through demulsification or active separation of oil and water in oil-in-water/water-in-oil emulsions, whether stable or unstable, acting to destabilize the emulsion (hinder stabilization) or accelerating such separation or destabilization.

Field case histories confirm the presence of undesirable emulsions in oil or condensate producing shale and tight gas sand formations after fracturing operations. It appears that the crude oil and condensate can exhibit emulsification tendencies after contacting filtrate that often leak back into the formation during fracturing. The resulting emulsions can significantly hinder well operations, including increasing pumping costs, as well as reduce the productivity of the well. The conventional response is to add chemical demulsifiers to the fracturing fluid, which causes separation or breaking of the emulsions. Applicants confirm, however, that the use of conventional demulsifiers with high pH fracturing fluids, such as high pH slick water and borate crosslinked or zirconium crosslinked fracturing fluid, may result in the formation of gunk, or other greasy, sticky residue or accumulation, which is undesirable and compromises the demulsifying process. Among other things, this also results in a reduction in the amount of the demulsifiers being distributed and effectively utilized. In many applications, the use of high pH fracturing fluids is required to maintain the effectiveness of the fracturing process or to minimize permeability damage in the formation. Thus, in one respect, the compositions and methods suggested in the present disclosure aim to provide for the use of a microemulsion additive in a high pH fracturing fluid to alleviate emulsions created or otherwise generated during and after fracturing operations, and more particularly, after fracturing operations in certain crude oil or condensate producing formations that exhibit emulsification tendencies.

A microemulsion according to the present disclosure may be formed by combining a solvent package (e.g. a solvent and co-solvent blend), an emulsifying surfactant, a non-emulsifier, and an aqueous fluid. In this composition, the solvent package and emulsifying surfactant are selected and provided in amounts necessary to provide the interface properties required for formation of the microemulsion. The microemulsion may be composed of about 20%-75% by weight of the solvent package, about 5%-20% by weight non-emulsifier, about 1%-10% by weight emulsifying surfactant, and about 2%-35% by weight water. In this composition, the microemulsion acts as an effective carrier of the non-emulsifier (the primary active agent). In applications involving high pH fluids, the highly miscible microemulsion of the present disclosure proves to be especially effective in preserving the non-emulsifier agent and distributing the agents throughout the fluid volume in the formation.

In another embodiment, the microemulsion is composed of a solvent (mixture solvent), a co-solvent-1, a co-solvent-2, a non-emulsifier, an emulsifying surfactant, alcohol, and water or brine. In some compositions, the microemulsion droplet sizes are in the range of about 5 nm to 100 nm. With reduced particle sizes, the microemulsion has the ability to more readily and quickly diffuse through the target emulsion, thereby encouraging separation. In various embodiments, the microemulsion includes one or more water wetting surfactants, e.g., a non-ionic surfactant and a non-ionic co-surfactant. The resulting microemulsion-based demulsifier composition allows for joint administration of these water wetting agents in one stable package or carrier. The carrier for these agents is also sufficiently stable to preserve the agents during the fluid application process and guard against loss of the agents in the rock matrix (e.g., through adsorption).

In certain compositions, the microemulsion additive comprises about 10%-35% by weight solvent, about 5%-20% by weight co-solvent, about 10%-35% by weight mutual solvent, about 5%-20% by weight non-emulsifier, about 1%-10% by weight non-ionic surfactant, about 1%-10% by weight non-ionic co-surfactant, about 1%-15% by weight alcohol, about 1%-10% by weight emulsifying surfactant, and about 2%-35% by weight water. The microemulsion forms upon simple mixing of the desired components and without high shear conditions, as generally known in the art. As described below, the resulting mixture is a thermodynamically stable, optically-clear, single phase Winsor Type IV microemulsion. Furthermore, in some embodiments the microemulsion is an oil-in-water emulsion with water providing the continuous or external phase while the remaining components are dispersed as droplets in the water external phase. Specifically, the solvent, co-solvent-1, co-solvent-2, non-emulsifier, non-ionic surfactant, a non-ionic co-surfactant, emulsifying surfactant, and alcohol provide the inner phase, with the surfactants concentrated at the interfaces.

As alluded to above, compositions are characterized by a capacity to efficiently carry one or more additive or agent components. A microemulsion serves as an excellent carrier because it offers improved solubilization of additives. In some compositions, the microemulsion composition carries a non-emulsifier and one or more non-ionic co-surfactants that act as water-wetting surfactants. Further, the compositions are highly miscible with high pH fluids and thus, the additive or agent components can be readily distributed (with the microemulsion) throughout the well and formation. For example, the demulsifying agent is provided at almost every surface of contact between the fracturing fluid filtrate and the crude oil or condensate. In contrast, conventional demulsifiers are often not as highly miscible with the aqueous fluid and allow contact between filtrate and crude oil or condensate product absent of demulsifier presence or action. Accordingly, the microemulsion advantageously carries and preserves the agent additive preventing premature spending of the agent additives (e.g., through adsorption on rock surfaces). In contrast, conventional demulsifiers that are only slightly miscible are likely to adsorb on rock surfaces and would not be available at the interface between the filtrate and fracturing fluid where demulsifying agent action is needed.

The microemulsion may be formulated and then added to the treatment fluid (or fracturing fluid) prior to well treatment. The resulting treatment fluid composition is introduced into the well on commencement of the well treatment. In one fracturing operation and fracturing fluid formulation, the microemulsion is provided at a concentration between about 0.05% and about 0.2% and in some embodiments between 0.05% and 0.1%, by volume of the fracturing fluid. The fracturing fluid has a relatively high pH—in the range of about 9 to 13 As suggested above, a high pH fracturing fluid to which the microemulsion is provided as an additive becomes particularly more effective in wells and adjacent formations that are otherwise susceptible to the formation of crude oil or condensate emulsions. More specifically, the microemulsion composition is highly miscible with the high pH fracturing fluid, whereas conventional chemical demulsifiers may not. Among other things, conventional use of demulsifiers does not have the benefit of the microemulsion system as a carrier. This allows the microemulsion and the demulsifiying agents carried therein to be maintained and distributed throughout the reservoir and well and act on all or substantially all possible oil and water (reservoir fluid) interfaces. Thus, in certain applications, a fracturing fluid is provided with the microemulsion additive at the specified concentration. The high pH fracturing fluid composition with the microemulsion additive is then pumped into the well to initiate a normal hydraulic fracturing process, while preventing emulsion formation otherwise induced by the fracturing fluid and filtrate. In one respect, the microemulsion additive imparts emulsion formation prevention properties to the fracturing fluid prior to introduction into the well.

For purposes of the present description, a “high pH” fracturing fluid shall mean and include fracturing fluids having a pH greater or equal to about 9 and as high as a pH of about 13 prior to mixing with the microemulsion additive and prior to introduction into the wellbore. Typical high pH fracturing fluids, with which the presently described microemulsion additive is well suited, includes borate crosslinked or zirconium crosslinked fracturing fluid, slick water, and other fracturing fluids that may not normally be of a high pH but a pH control agent is added to increase the pH prior to pumping. Fracturing operations contemplated by the present disclosure in which the microemulsion additive may be employed include fracturing using slick water at a pH of about 7 and higher and zirconium or borate-crosslinked fracturing fluid at a pH of about 11.

It should be noted that results arising from the use of the subject fluid composition and methods, as described herein, are not strictly limited to use with high pH treatment fluids. Present methods and compositions that utilize a high pH treatment fluid may, indeed, be made more effective through use of the described microemulsion additive. The subject methods and fluid compositions may also be used, however, with treatment fluids having a pH well below 9. The performance of the compositions and methods in these other applications is not expected to deviate substantially if the pH of the treatment fluid is the only factor to significantly change.

The solvent or mixture solvent in some embodiments is non-toxic, and in some embodiments, compatible with water. In one embodiment, a mixture solvent is selected from the group of methyl esters, such as methyl caprylate, methyl caprate, methyl laurate, methyl myristate, methyl palmitate, methyl oleate, N,N-dimethylcaprylamide, N,N-dimethylcapramide, methyl linoleate and methyl linolenate. In one embodiment, the solvent selected is methyl caprylate/caprate and more specifically, one manufactured and sold under the trade name STEPOSOL C-25 by Stepan Company in Northfield, Ill. Further the co-solvent may be selected and added to achieve the desired solubility characteristics in the microemulsion. In the embodiment, the co-solvent-1 selected is alkoxylated solvent such as one made available under the trade name Surftreat 9294 by Clariant Oil Services in Houston, Tex. In some embodiments, the co-solvent 2 is a mutual solvent selected for its oil and water solubility properties and as necessary to effect the interfacial tension and form the single phase water external microemulsion system desired. In these embodiments, the mutual solvent may be selected from the group consisting of propylene glycol t-butyl ether, dipropylene glycol monomethyl ether, propylene glycol n-propyl ether and tripropylene glycol monomethyl ether. In one embodiment, the selected co-solvent 2 or mutual solvent is dipropylene glycol monomethyl ether which is made available under the trade name DOWANOL DPM by Dow Chemical Company in Midland, Mich. It will also be understood that, in specific applications and in response to specific needs or preferences, certain suitable combinations of different solvents may be used for each of the mixture solvent, co-solvent-1, and\or mutual solvent. Such combinations are contemplated by and are encompassed by the disclosed concepts.

Generally, a suitable non-ionic surfactant is one that encourages formation or stabilization of the microemulsion system and also provides a water-wetting surfactant agent to the microemulsion composition. The surfactant system of certain embodiments includes first and second non-ionic surfactants, both of which are water-wetting surfactants. The first surfactant is provided so as to ensure that the rock surface remains water-wet. The second surfactant is provided to ensure a sharp (very clean) break at the interface between oil and water, and a clear aqueous phase (free of oil). The water-wetting surfactants act on the rock surfaces and enhances oil recovery, as well known in the art. The primary non-ionic surfactant selected in some embodiments is an alcohol ethoxylate and, in some specific embodiments, alkyl alcohol ethoxylates with carbon-chain lengths between about 9 and 11. Such a suitable non-ionic surfactant is one manufactured and sold under the trade name Tomadol 900 by Air Products in Milton, Wis. The co-surfactant may be added to increase solubilizing properties of the surfactant system and ensure appropriately low surface tension at the interfaces. The non-ionic co-surfactant selected in some embodiments is an alcohol alkoxylate and in some embodiments, an alcohol alkoxylate containing short-chain alkyl groups with carbon-chain lengths between 2 and 4. Such a non-ionic co-surfactant is a product manufactured and sold under the trade name GT 2624 by Akzo Nobel in Chicago, Ill. A suitable concentration for each of the surfactant and co-surfactant is 3% by weight.

The microemulsion may utilize a green non-emulsifier as the primary emulsion formation prevention agent. A “green” non-emulsifier is understood to be component that is of low toxicity and biodegradable. In some embodiments, the green non-emulsifier is selected from the group including a block polymer, amine block polymer, sorbitan alkanoate, alkoxylates, fatty alcohol ethoxylate, fatty acide ethoxylate, diepoxide, polyamine, 2-ethyl-1-hexanol, nonyl/butyl base catalyzed resin and nonyl/butyl acide catalyzed resin. Such a suitable green non-emulsifier is a product manufactured and sold under the trade name Phasetreat 6849 by Clariant Oil Services in Houston, Tex.

A suitable emulsifying surfactant is one that, in balance with the solvent components, leads to the desired microemulsion system (i.e., single phase, water-external). The emulsifying surfactant concentrates at the oil and water interface of the microemulsion, reducing its surface tension and stabilizing the microemulsion. The emulsifying surfactant in some embodiments is non-reactive with the other components and remains stable in the microemulsion. In some embodiments, the emulsifying surfactant is selected from the group of polysorbates, such as polyoxyethylene (20) sorbitan monolaurate, polyoxyethylene (20) sorbitan monoplamitate, polyoxyethylene (20) sorbitan monooleate and polyoxyethylene (20) sorbitan monostearate. A suitable oil-solubilizing surfactant is polyoxyethylene (20) sorbitan monooleate.

The alcohol component in the composition serves as a coupling agent between solvents and surfactants, thereby stabilizing the microemulsion. In some embodiments, isopropanol may be employed in compositions. Other suitable alcohols include primary, secondary, and tertiary alcohols with between 1 and 20 carbon atoms such as t-butano, n-butanol, n-pentanol, n-hexanol, and 2-ethyl-hexanol.

The aqueous fluid used may be freshwater, brine, other water-based fluids, or combinations thereof. Generally, the aqueous fluid may be any such fluid that is suitable for the target microemulsion and will not adversely impact the properties desired of the microemulsion. Furthermore, the aqueous fluid selected should be environmental-friendly. In various embodiments, the concentration of the aqueous fluid in the microemulsion composition is between about 2% and 35% by weight, and in some embodiments, between about 10% and 30% by weight.

Accordingly, compositions for the microemulsion additive may comprise the following:
10%-35% by weight methyl ester (solvent);
5%-20% by weight dipropylene glycol monomethyl ether (co-solvent);
10%-35% by weight alcoxylated solvent (mutual solvent);
5%-20% by weight PHASETREAT 6869 (non-emulsifier);
1%-10% by weight linear ethoxylated alcohol (non-ionic surfactant);
1%-10% by weight short chained alcohol alkoxylate (non-ionic co-surfactant):
1%-15% by weight isopropyl alcohol (alcohol);
1%-10% by weight sorbitan monooleate (emulsifying surfactant); and
2%-35% by weight water.

In certain fracturing fluid compositions, the microemulsion additive specified above is added to a borate-crosslinked or slick water fracturing fluid at a concentration of 0.05% to 0.1% by volume of the fracturing fluid. The microemulsion additive mixes almost simultaneously into the fracturing fluid with little shearing effort. Examples of suitable or advantageous fracturing fluids and fracturing fluid compositions containing the microemulsion additive are also suggested in the Examples and testing described below. The microemulsion additive imparts emulsion prevention properties to the fracturing fluid composition.

### EXAMPLES

### Miscibility of Microemulsion Additive in Water

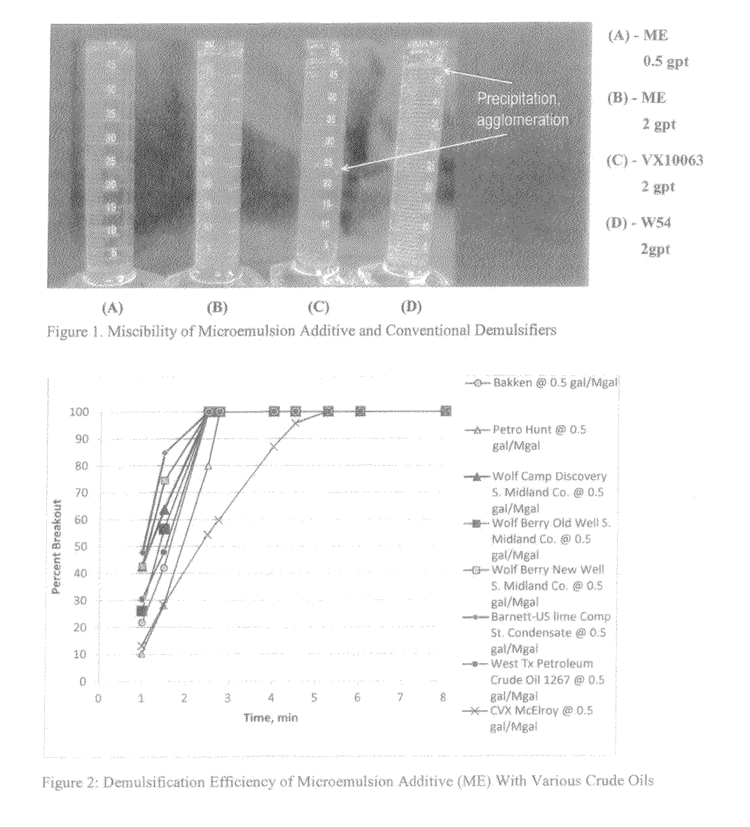

The miscibility of the microemulsion additive according to the present disclosure in water was compared with that of two types of conventional demulsifiers. The two conventional demulsifiers selected for comparisons were a demulsifier made available as VX 10063 by Nalco Company of Napierville, Ill. and a demulsifier designated herein as W54 and made available in the United States, among other places, by Schlumberger Limited. Table 1 provides the composition of the microemulsion additive used in the comparisons. Each of the conventional demulsifiers was mixed in the water at a concentration of 2 gpt. The microemulsion additive was mixed in water at concentrations of 0.5 gpt and at 2 gpt. FIG. 1 is a photograph of the four mixtures after sitting 72 hours at ambient temperature. The first mixture (A) containing 0.5 gpt of microemulsion additive (ME) in water is substantially clear and free of any precipitation or agglomeration. The second sample (B), which contains the microemulsion additive (ME) at 2 gpt in water, is less clear but appears to be free of any precipitation or agglomeration. Thus, the microemulsion additive may be characterized as being highly or completely miscible in both samples.

TABLE 1
Example Composition of a Microemulsion (ME)

| COMPONENT | % BY WEIGHT |
|---|---|
| Methyl ester (solvent) | 29.2 |
| Dipropylene glycol | 12.0 |
| monomethyl ether (co-solvent) | |
| Alcoxylated solvent | 24.0 |
| (SURFTREAT 9294) | |
| PHASETREAT 6869 (non- | 12.4 |
| emulsifier) | |
| Linear alkoxylated alcohol | 8.0 |
| (non-ionic surfactant) | |
| Short-chained alcohol | 5.86 |
| alkoxylate (non-ionic co- | |
| surfactant) | |
| Isopropyl alcohol | 4.0 |
| Sorbitant monooleate | 1.79 |
| (emulsifying surfactant) | |
| Water | 2.75 |

On the other hand, the mixtures (C), (D) with 2.0 gpt conventional demulsifiers exhibited precipitation and\or agglomeration of the demulsifier. The mixture (C) with 2 gpt of VX10063 in water clearly contains white-colored agglomerations floating in the sample (as indicated by the reference arrow). The other sample mixture (D) exhibit precipitation floating at the liquid surface. It is concluded, therefore, that the miscibility of the microemulsion additive of the present disclosure is substantially more miscible in water than the two conventional demulsifiers.

### Compatibility Tests

The microemulsion (ME) composed according to Table 1 was presented for a series of tests. First, compatibility tests were conducted by performing standard non-emulsion tests in accordance with the procedure given by the American Petroleum Institute Publication API RP-42, “Recommended Practices for Laboratory Evaluation of Surface Active Agents for Well Stimulation.” This procedure is routinely used to test compatibility between acidizing fluids and crude oils. It was used here to evaluate the performance of the microemulsion in demulsifying or breaking down crude oil-treatment fluid emulsions.

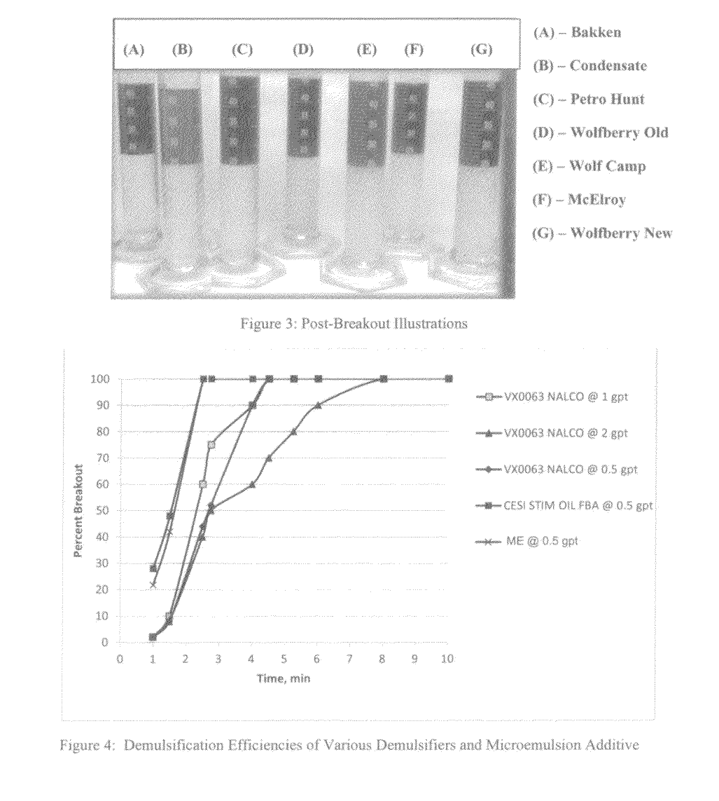

The microemulsion (ME) was added to a treatment fluid consisting of 4% KCl brine at a concentration of about 0.05% by volume of the treatment fluid. The pH of the treatment fluid was adjusted to 10.9 so as to simulate that of borate-crosslinked fluids. For screening purposes, 25 ml of crude oil and 25 ml of the high pH brine were blended at a uniform speed for 60 seconds in a Waring blender. The resulting mixture was transferred immediately to a graduated cylinder and placed in a water bath set at 155° F. Water/oil separation was measured as a function of time, and as shown in FIG. 3, data was plotted as % breakout (volume of oil separated (top phase)/total oil volume) water/oil phase separation) versus time. For evaluation purposes, compatibility between crude oil and 4% KCl brine was defined as 100% phase separation or breakout within 30 minutes (at ambient temperatures).

After the compatibility tests, the wettability characteristics of the mixtures were evaluated by physically observing the crude oil tendencies at or near the surface of the graduated cylinder. “Poor” wettability characteristics were found if crude oil was found to “cling” to the glass surface and did not move freely along the surface. The oil and water phases of the mixtures were then visually inspected for purity. Specifically, for each mixture, the oil phase was inspected for any presence of brine trapped in that phase and the brine phase was inspected for trapped oil. A mixture (or, more precisely, a microemulsion additive associated with the mixture) was evaluated favorably if found to have an oil phase substantially clear of brine or a brine phase substantially clear of oil. Further, the interface between the brine and oil phases was visually inspected and evaluated. An interface was evaluated favorably if distinct phase separation could be observed (i.e. sharp and well defined) without any rag or emulsion layer.

Next, compatibility between the fracturing fluid and the microemulsion additive (ME) was determined. After adding the microemulsion to the fracturing fluid, the viscosity of the resulting mixture was measured and compared to that of the fracturing fluid without the microemulsion additive (ME). Finally, the fracturing fluid containing the microemulsion additive (ME) was broken with a suitable breaker. The resulting fluid was subsequently filtered to obtain an effluent. An oil\water separation test was then performed on this effluent with crude oil.

### Test Results

FIG. 2 reveals the results of the first compatibility tests and the demulsification efficiency of the 0.05% microemulsion additive (ME) (in the treatment fluid) as tested with various crude oils. As displayed, the microemulsion additive (ME) consistently initiated brine breakout immediately upon mixing and, with the exception of the case of one crude oil-treatment fluid mixture, achieved complete breakout within 3 minutes. The single exception did exhibit complete breakout within about 5 minutes. As illustrated by FIG. 3, each of the resulting post-breakout samples (A)-(D) is characterized by sharp and distinct interfaces between oil and brine, and brine phases that are practically oil-free. It appears, therefore, that the microemulsion additive (ME) in a high pH treatment fluid is effective in demulsifying and preventing emulsion formation in a mixture of the treatment fluid and crude oils.

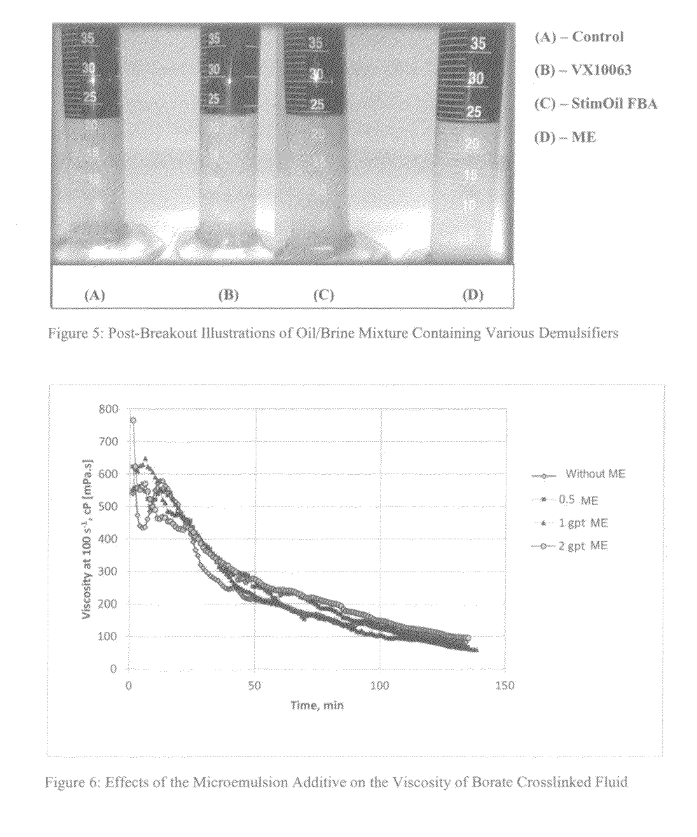

Now referring to FIG. 4, the demulsification efficiency of the microemulsion additive (ME) in the treatment fluid and using Bakken crude oil was compared with that of commercially-available demulsifiers. The two demulsifiers are a conventional demulsifier, VX10063, from Nalco Company of Napierville, Ill., and one described as a nanofluid/micro emulsion blend available as STIMOIL FBA M from CESI Chemical of Houston, Tex. As displayed in FIG. 4, Bakken crude oil and brine mixtures containing either the microemulsion additive (ME) or the StimOil FBA demulsifier achieved complete breakout in less than three minutes. The three mixtures containing different concentrations of the VX10063 demulsifier generally took twice as long to separate. As illustrated in FIG. 5, observations of corresponding post-breakout samples (A)-(D) revealed that the sample (D) treated with the microemulsion additive (ME) exhibited a sharp interface and a clear brine phase. On the other hand, the samples (B), (C) treated with VX10063 and STIMOIL FBA demulsifiers each exhibited a somewhat diffused interface and a brine phase containing oil droplets. This suggests that, in terms of demulsification efficiency, the microemulsion additive (ME) performed better in these experiments than the other two tested demulsifiers.

As for wettability, each of the graduated cylinders (A)-(G) (in FIG. 3) containing microemulsion-treated fluids was inspected for evidence of oil about the glass walls bounding the brine phase. As shown in FIG. 3, the glass walls of these cylinders were found to be free or substantially free of any oil adherence. This finding indicates that the glass surface remained water wet and that the microemulsion (ME) did not alter the water-wetting characteristics of the glass surface. In comparison, the graduated cylinders containing the fluid mixtures that were not treated with the microemulsion (ME) were found to have crude oil on the glass surface bounding the brine phase. See e.g., cylinders (B), (C) in FIG. 5. The evidence of crude oil was further observed to cling to the surface and not move freely. Thus, it was concluded that the treatment fluid mixtures treated with the microemulsion (ME) exhibited good wettability in respect to the glass surface. In contrast, the non-treated mixtures were concluded as exhibiting “poor” wettability characteristics.

It is concluded that a couple of factors encourage and make possible the higher demulsification rates and effectiveness attainable through use of the microemulsion additive of the present disclosure. First, the microemulsion is characterized by reduced droplets size, which is estimated to be between about 50 to 100 nm. Furthermore, the micromemulsion exhibits an ability, associated with the reduced droplet size, to readily diffuse through the target emulsion thereby effecting rapid separation.

The graph of FIG. 6 shows the effect of the addition of the microemulsion additive (ME) on the viscosity of a borate-crosslinked fracturing fluid containing 0.3% guar. More specifically, the graph shows that the viscosity of the fracturing fluid after adding each of three different concentrations of the microemulsion additive is not significantly changed. This suggests that the addition of the microemulsion additive of the present disclosure has practically no effect on the viscosity of the borate-crosslinked fluid.

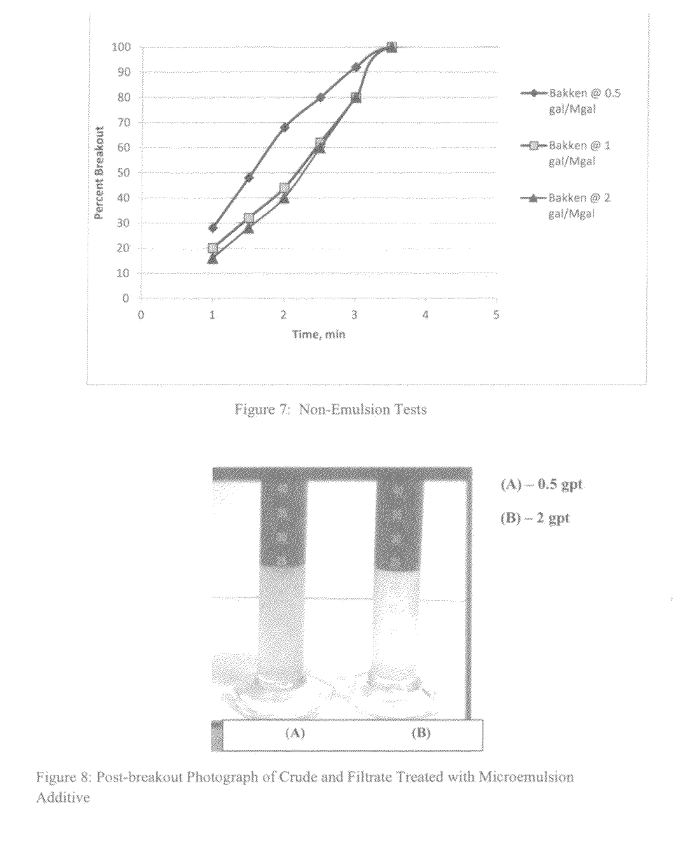

The fracturing fluid containing the microemulsion additive (ME) was subsequently broken with ammonium persulfate. The broken fluid was then filtered, and the filtrate was used in a non-emulsion test using crude oil from Bakken formation. The results displayed in FIG. 7 show that the oil quickly separated from the filtrate. In addition, the oil and water phases were separated by a sharp interface and the brine phase was free of oil. This suggests that the filtrate retained a sufficient amount of the microemulsion additive (ME). This also suggests that the microemulsion and fracturing fluid composition according to the present disclosure can be readily recovered from a subterranean well and after a fracturing operation.

In the foregoing specification, the subject methods and compositions have been described with references to specific embodiments thereof, and have been suggested as effective in providing methods and compositions for preventing emulsion formation. It will be evident to one skilled in the relevant geophysical, engineering, or chemical art, however, that various modifications and changes may be made thereto without departing from the broader spirit or scope of the application as set forth in the appended claims. Accordingly, the specification is to be regarded in an illustrative rather than a restrictive sense. For example, the well treatment methods described may be modified or adapted to include or incorporate well treatment techniques not described herein but practiced in the industry. Methods may also be modified to employ or involve treatment fluid compositions other than the fracturing fluid compositions described.

What is claimed is:

1. A method for treating a formation adjacent a subterranean well with a treatment fluid composition imparted with emulsion formation prevention properties, said method comprising:
providing a treatment fluid component;
mixing a microemulsion additive into the treatment fluid component to form a volume of a treatment fluid composition having emulsion formation prevention properties, wherein the microemulsion additive comprises a solvent package, a non-emulsifier, an emulsifying surfactant, and an aqueous fluid; and
injecting the volume of the fluid composition into the subterranean well and contacting the formation therewith, thereby effecting the well treatment and whereby the microemulsion additive in the treatment fluid volume acts to prevent emulsion formation in the formation.

2. The method of claim 1, wherein the microemulsion additive further comprises a water wetting surfactant.

3. The method of claim 1, wherein the treatment fluid component is a fracturing fluid and the injecting step includes pumping the volume of fluid composition to generate fractures in the formation.

4. The method of claim 1, wherein the treatment fluid has a pH between about 9 and about 13.

5. The method of claim 1, wherein mixing the microemulsion additive into the treatment fluid includes adding the microemulsion additive at a concentration of between about 0.05% to about 0.2% by volume of the treatment fluid.

6. The method of claim 1, wherein the microemulsion additive comprises:
between about 10% and about 35% by weight mixture solvent;
between about 5% and about 20% by weight co-solvent;
between about 10% and about 35% by weight mutual solvent;
between about 5% and about 20% by weight non-emulsifier;
between about 1% and about 10% by weight non-ionic surfactant;
between about 1% and about 10% by weight non-ionic co-surfactant;
between about 1% and about 15% by weight alcohol;
between about 1% and about 10% by weight emulsifying surfactant; and
between about 2% and about 35% by weight water.

7. The method of claim 1, further comprising providing a microemulsion additive by mixing a mixture solvent, a co-solvent, a mutual solvent, a non-emulsifier, a non-ionic surfactant, a non-ionic co-surfactant, an alcohol, an emulsifying surfactant, and water to form a single-phase, water-external microemulsion.

8. The method of claim 7, wherein the mixture solvent is selected from the group consisting of: methyl caprate, methyl laurate, methyl myristate, methyl palmitate, methyl oleate, N,N-dimethylcaprylamide, N,N-dimethylcapramide, methyl linoleate, and methyl linolenate;
wherein the co-solvent is an alkoxylated solvent;
wherein the mutual solvent is selected from the group consisting of: propylene glycol t-butyl ether, dipropylene glycol monomethyl ether, propylene glycol n-propyl ether, and tripropylene glycol monomethyl ether;
wherein the non-emulsifier is selected from the group consisting of: block polymer, amine block polymer, sorbitan alkanoate, alkoxylates, fatty alcohol ethoxylate, fatty acide ethoxylate, diepoxide, polyamine, 2-ethyl-1-hexanol, nonyl/butyl base catalyzed resin, and nonyl/butyl acid catalyzed resin;
wherein the non-ionic surfactant is an alcohol ethoxylate;
wherein the non-ionic co-surfactant is an alcohol alkoxylate;
wherein the alcohol is selected from the group consisting of: isopropylalcohol; t-butanol, n-butanol, n-pentonol, n-hexanol, and 2-ethyl-hexanol; and
wherein the emulsifying surfactant is a polysorbate.

9. The method of claim 7, wherein the mixture solvent is a methyl caprylate/caprate, the co-solvent is dipropylene glycol monomethyl ether, the mutual solvent is alcohol ethoxylate, the non-emulsifier is 2-ethyl-1-hexanol, the non-ionic surfactant is linear alcohol ethoxylate, the non-ionic co-surfactant is short chain alcohol alkoxylate, the alcohol is isopropyl alcohol, the emulsifying surfactant is polyoxyethelene sorbitan monooleate (20), and the aqueous fluid is water.

10. A microemulsion additive composition for adding to a well treatment fluid and imparting emulsion formation prevention properties to the treatment fluid, said composition comprising:
a solvent package, a non-emulsifier, a water wetting surfactant, an emulsifying surfactant, and an aqueous fluid; and
wherein components of the composition form a single-phase Winsor IV microemulsion and wherein the aqueous fluid provides an external phase of the microemulsion.

11. The composition of claim 10, wherein the solvent package includes a mixture solvent, a co-solvent, and a mutual solvent, and the water wetting surfactant is a non-ionic surfactant, the composition further comprising:
a non-ionic co-surfactant; and
alcohol; and
wherein the microemulsion comprises:
between about 10% and about 35% by weight mixture solvent,
between about 5% and about 20% by weight co-solvent,
between about 10% and about 35% by weight mutual solvent,
between about 5% and about 20% by weight non-emulsifier,
between about 1% and about 10% by weight non-ionic surfactant,
between about 1% and about 10% by weight non-ionic cosurfactant;
between about 1% and about 15% by weight alcohol,
between about 1% and about 10% by weight emulsifying surfactant, and
between about 10% and about 30% by weight aqueous fluid; and
wherein both the non-ionic surfactant and the non-ionic co-surfactants are water wetting surfactants.

12. The composition of claim 11, wherein the non-emulsifier is selected from the group consisting of: block polymer, amine block polymer, sorbitan alkanoate, alkoxylates, fatty alcohol ethoxylate, fatty acide ethoxylate, diepoxide, polyamine, 2-ethyl-1-hexanol, nonyl/butyl base catalyzed resin and nonyl/butyl acid catalyzed resin.

13. The composition of claim 11, wherein the non-ionic surfactant is linear alcohol ethoxylate.

14. The composition of claim 11, wherein the non-ionic co-surfactant is alcohol alkoxylate with short-chain alkyl groups having carbon-chain lengths between 2 and 4.

15. The composition of claim 11, wherein the emulsifying surfactant is a polysorbate.

16. The composition of claim 11, wherein the mixture solvent is selected from the group consisting of: methyl caprylate, methyl caprate, methyl laurate, methyl myristate, methyl palmitate, methyl oleate, N,N-dimethylcaprylamide, N,N-dimethylcapramide, methyl linoleate and methyl linolenate;
wherein the co-solvent is an alkoxylated solvent; and
wherein the mutual solvent is selected from the group consisting of: propylene glycol t-butyl ether, dipropylene glycol monomethyl ether, propylene glycol n-propyl ether and tripropylene glycol monomethyl ether.

17. A method of preventing emulsion formation in a subterranean well and adjacent formation, said method comprising:
preparing a microemulsion additive composition comprising a single phase water-external microemulsion comprising a mixture solvent, a co-solvent, a mutual solvent, a non-emulsifier, a non-ionic surfactant, a non-ionic co-surfactant, alcohol, an emulsifying surfactant, and water;
preparing a well treatment fluid;
mixing the microemulsion additive into the well treatment component to form a volume of a treatment fluid composition having emulsion prevention properties, wherein the microemulsion additive composition is miscible in the treatment fluid; and
introducing a volume of the treatment fluid composition into the subterranean well and contacting the formation therewith for treatment, whereby the microemulsion additive in the treatment fluid volume acts to prevent oil emulsion formation inside the well and formation contacted by the treatment fluid volume.

18. The method of claim 17, wherein the mixture solvent is selected from the group consisting of: methyl caprylate, methyl caprate, methyl laurate, methyl myristate, methyl palmitate, methyl oleate, N,N-dimethylcaprylamide, N,N-dimethylcapramide, methyl linoleate, and methyl linolenate;
wherein the co-solvent is an alkoxylated solvent;
wherein the mutual solvent is selected from the group consisting of: propylene glycol t-butyl ether, dipropylene glycol monomethyl ether, propylene glycol n-propyl ether, and tripropylene glycol monomethyl ether;
wherein the non-emulsifier is selected from the group consisting of: block polymer, amine block polymer, sorbitan alkanoate, alkoxylates, fatty alcohol ethoxylate, fatty acide ethoxylate, diepoxide, polyamine, 2-ethyl-1-hexanol, nonyl/butyl base catalyzed resin, and nonyl/butyl acid catalyzed resin;
wherein the non-ionic surfactant is an alcohol ethoxylate;
wherein the non-ionic co-surfactant is an alcohol alkoxylate;
wherein the alcohol is selected from the group consisting of: isopropylalcohol; t-butanol, n-butanol, n-pentonol, n-hexanol, and 2-ethyl-hexanol; and
wherein the emulsifying surfactant is a polysorbate.

19. The method of claim 17, wherein the treatment fluid composition is a high pH fracturing fluid and introducing the volume of treatment fluid includes introducing the treatment fluid composition into the well to hydraulically fracture the adjacent formation.

20. The method of claim 19, wherein mixing the microemulsion additive includes mixing a concentration of the additive between about 0.05% to about 0.2% by volume of well treatment fluid.
